(19) United States
(12) Patent Application Publication
(10) Pub. No.: US 2023/0261593 A1
(43) Pub. Date: Aug. 17, 2023

(54) SEMICONDUCTOR INTEGRATED CIRCUIT DEVICE FOR DRIVING MOTOR, MOTOR SYSTEM AND FAN

(71) Applicant: ROHM CO., LTD., Kyoto-shi (JP)

(72) Inventors: Tomoaki KUROBE, Kyoto-shi (JP); Yuki GOHARA, Kyoto-shi (JP)

(21) Appl. No.: 18/165,464

(22) Filed: Feb. 7, 2023

(30) Foreign Application Priority Data
Feb. 14, 2022 (JP) 2022-020218

(51) Int. Cl. H02P 6/12; H02P 6/08; G06F 1/20

(52) U.S. Cl. CPC H02P 6/12; G06F 1/206; H02P 6/08

(57) ABSTRACT

The present disclosure provides a motor driving semiconductor integrated circuit (IC) device. The motor driving semiconductor IC device includes a receiver and a control unit. The receiver is configured to receive a first rotational frequency information transmitted by another motor driving semiconductor IC device. The control unit is configured to variably control a rotational frequency of a self-driven motor according to the first rotational frequency information.

### CROSS REFERENCES TO RELATED APPLICATIONS

The present invention claims priority under 35 U.S.C. §119 to Japanese Application, 2022-020218, filed on Feb. 14, 2022, the entire contents of which being incorporated herein by reference.

### TECHNICAL FIELD

The present disclosure of the application relates to a motor driving technique.

### BACKGROUND

Accompanied by high-speed computers, operation speeds of computing processes of large-scale integration (LSI) circuits such as central processing units (CPU) or digital signal processors (DSP) continue to rise. Along with the operation speeds of such LSI circuits, that is, the increase in clock frequencies, the amount of generated heat also increases. The heat generated by LSI circuits may lead to issues of thermal runaway of the LSI circuits or influences on peripheral circuits. Thus, proper thermal cooling for LSI circuits is extremely critical.

An example of a technique for LSI cooling is an air cooling method by fan cooling (for example, referring to patent publication 1). In the above method, for example, a cooling fan is disposed opposite to a surface of an LSI circuit, and cold air is blown by the cooling fan to the LSI circuit, or a heat sink mounted thereon.

### PRIOR ART DOCUMENT

### Patent Publication

[Patent document 1] Japan Patent Publication No. 2014 -103786

### SUMMARY

### Problems to be Solved by the Present Disclosure

Accompanied with high-speed computers, enhanced cooling efficiency of cooling fans is desired. A common cooling fan is a single-unit cooling air cooling fan formed by one fan.

FIG. 1 shows a diagram of configuration of a circuit of a motor system of a single-unit air cooling fan. A motor driving semiconductor integrated circuit device 100 includes a VCC terminal T1 input with a voltage VCC, a GND terminal T2 connected to ground; a PWM terminal T3 input with a PWM signal that controls a rotation of a motor M0, and an SO terminal T4 outputting rotational frequency information indicating a rotational frequency of the self-driven motor M0.

The motor driving semiconductor integrated circuit device 100 receives the PWM signal that controls the rotation of the motor M0 from a controller CT0 such as a microcomputer and performs rotational frequency control of a fan according to the received PWM signal.

In case of an anomaly in the motor M0, the controller CT0 detects the anomaly from rotational frequency information indicating the rotational frequency of the motor M0 driven by the motor driving semiconductor integrated circuit device 100 and stops the power supply to the fan or stops the motor M0.

In a single-unit air cooling fan, wind spreads broadly relative to the direction of rotation of the fan. In a double reverse rotation fan, two fans that reverse the direction of rotation of impellers are arranged in series. The double reverse rotation fan is a fan that rotates in an opposite direction at the rear, which weakens a swirling flow of the wind from the front fan and inhibits spreading of the wind, hence generating a straight-traveling wind. Thus, the double reverse rotation fan cools more efficiently than a single-unit air cooling fan.

In a double reverse rotation fan, in case of an anomaly occurring in one fan, the spreading of wind cannot be inhibited, and an air cooling capability thus cannot be fully exercised.

In addition, apart from an air cooling fan, in a device using numerous motors, there is a concern of a reduced capability in case of an anomaly of part of the motors.

### Technical Means for Solving the Problem

A motor driving semiconductor integrated circuit device disclosed by the present application includes: a receiver configured to receive first rotational frequency information transmitted by another motor driving semiconductor integrated circuit device; and a control unit configured to variably control a rotational frequency of a self-driven motor according to the first rotational frequency information.

A motor system disclosed by the present application includes the motor driving semiconductor integrated circuit device of the above configuration.

A fan disclosed by the present application includes the motor system of the above configuration.

### Effects of the Disclosure

The motor driving semiconductor integrated circuit device, the motor system and the fan according to the disclosure of the present application are capable of monitoring a rotation state of a motor and compensating a capability of a malfunctioning motor.

### BRIEF DESCRIPTION OF THE DRAWINGS

FIG. 1 is a diagram of configuration of a circuit of a motor system of a single-unit air cooling fan.

FIG. 2 is a diagram of configuration of a circuit of a motor system of a double reverse rotation fan.

FIG. 3 is a diagram of a structure of a double reverse rotation fan.

FIG. 4A is a diagram of curves of rotational frequency characteristics of a fan in a normal operation.

FIG. 4B is a diagram of curves of rotational frequency characteristics of a fan in a normal operation.

FIG. 5A is a diagram of curves of rotational frequency characteristics of fans in an abnormal operation.

FIG. 5B is a diagram of curves of rotational frequency characteristics of fans in an abnormal operation.

FIG. 6 is a diagram of rotational frequency information during an abnormal operation (a motor rotating at a low speed).

FIG. 7A is a diagram of rotational frequency information during an abnormal operation (a locked motor).

FIG. 7B is a diagram of rotational frequency information during an abnormal operation (a locked motor).

FIG. 8 is a diagram of a brief configuration example of a computer.

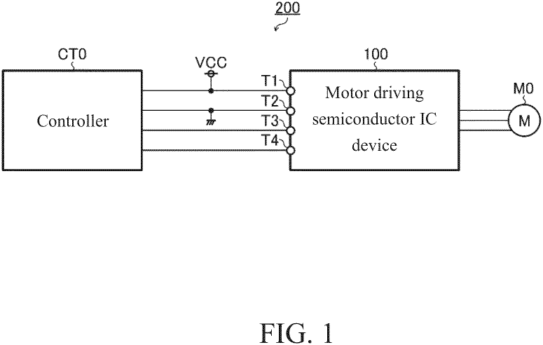

### DETAILED DESCRIPTION OF THE EMBODIMENTS

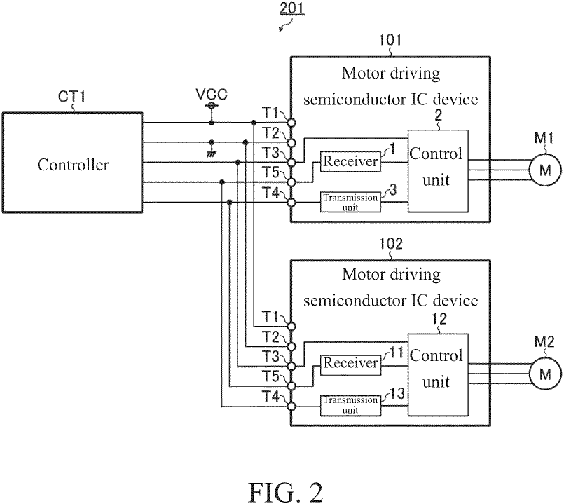

FIG. 2 shows a diagram of configuration of a circuit of a motor system of a double reverse rotation fan. A motor driving semiconductor integrated circuit (IC) device 101 includes: a VCC terminal T1 input with a voltage VCC; a GND terminal T2 connected to ground; a PWM terminal T3 input with a PWM signal that controls rotations of motors M1 and M2; an SO terminal T4 outputting rotational frequency information indicating a rotational frequency of the self-driven motor M1; and an SI terminal T5 input with rotational information indicating a rotational frequency of the motor M2 driven by another motor driving semiconductor integrated circuit device 102. The motor driving semiconductor integrated circuit (IC) device 102 includes: a VCC terminal T1 input with a voltage VCC; a GND terminal T2 connected to ground; a PWM terminal T3 input with a PWM signal that controls the rotations of the motors M1 and M2; an SO terminal T4 outputting the rotational frequency information indicating the rotational frequency of the self-driven motor M2; and an SI terminal T5 input with the rotational information indicating a rotational frequency of the motor M1 driven by the other motor driving semiconductor integrated circuit device 101. The VCC terminal T1 of the motor driving semiconductor integrated circuit device 101 and the VCC terminal T1 of the motor driving semiconductor integrated circuit device 102 are electrically connected by, for example, a wire formed on a printed wiring substrate. The GND terminal T2 of the motor driving semiconductor integrated circuit device 101 and the GND terminal T2 of the motor driving semiconductor integrated circuit device 102 are electrically connected by, for example, a wire formed on a printed wiring substrate. The PWM terminal T3 of the motor driving semiconductor integrated circuit device 101 and the PWM terminal T3 of the motor driving semiconductor integrated circuit device 102 are electrically connected by, for example, a wire formed on a printed wiring substrate. The SO terminal T4 of the motor driving semiconductor integrated circuit device 101 and the SI terminal T5 of the motor driving semiconductor integrated circuit device 102 are electrically connected by, for example, a wire formed on a printed wiring substrate. The SI terminal T5 of the motor driving semiconductor integrated circuit device 101 and the SO terminal T4 of the motor driving semiconductor integrated circuit device 102 are electrically connected by, for example, a wire formed on a printed wiring substrate.

The motor driving semiconductor integrated circuit device 101 includes: a receiver 1 configured to receive first rotational frequency information transmitted by the other motor driving semiconductor integrated circuit device 102; a control unit 2 configured to variably control the rotational frequency of the self-driven motor M1 according to the first rotational frequency information; and a transmission unit 3 configured to send second rotational frequency information indicating the rotational frequency of the self-driven motor M1 to the other motor driving semiconductor integrated circuit device 102.

The motor driving semiconductor integrated circuit device 102 includes: a receiver 11 configured to receive the first rotational frequency information transmitted by the other motor driving semiconductor integrated circuit device 101; a control unit 12 configured to variably control the rotational frequency of the self-drive motor M2 according to the first rotational frequency information; and a transmission unit 13 configured to send second rotational frequency information indicating the rotational frequency of the self-driven motor M2 to the other motor driving semiconductor integrated circuit device 101.

The plurality of motor driving semiconductor integrated circuit devices 101 and 102 receive the PWM signals that control the rotations of the motors M1 and M2, and respectively perform rotational frequency control of a plurality of fans according to the received PWM signals.

The plurality of motor driving semiconductor integrated circuit devices 101 and 102 receive and transmit the rotational frequency information indicating the rotational frequencies of the self-driven motors and the rotational frequency information indicating the rotational frequencies of the motor driven by the other motor driving semiconductor integrated circuit devices, and mutually monitor anomalies of the motors driven respectively.

A motor system 201 includes the plurality of motor driving semiconductor integrated circuit devices 101 and 102, and the plurality of motors M1 and M2 respectively driven by the plurality of motor driving semiconductor integrated circuit devices 101 and 102.

The plurality of motor driving semiconductor integrated circuit devices 101 and 102 are respectively configured to transmit the second rotational frequency information indicating the rotational frequencies of the self-driven motors and receive the first rotational frequency information indicating the rotational frequencies of the motors driven by the other motor driving semiconductor integrated circuit devices.

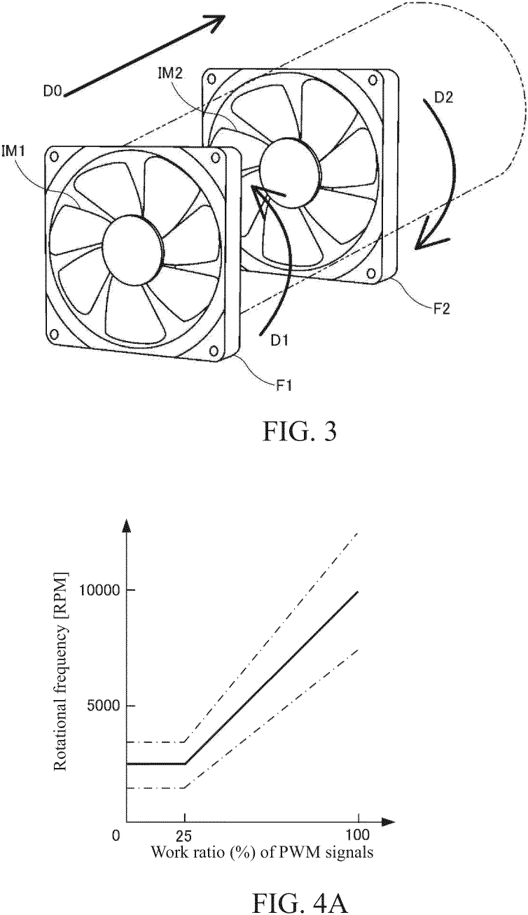

FIG. 3 shows a diagram of a structure of a double reverse rotation fan. The double reverse rotation fan shown in FIG. 3 includes fans F1 and F2. The fan F1 includes an impeller IM1, and the motor M1 (not shown in FIG. 3) that rotates the impeller IM1. The fan F2 includes an impeller IM2, and the motor M2 (not shown in FIG. 3) that rotates the impeller IM2. Directions of rotation of the front impeller IM1 and the rear impeller IM2 are different. When two fans having the same direction of rotation are connected in series, since the rear impeller IM2 further enhances and discharges a swirling wind from the front, air spreads and flows.

On the other hand, with the double reverse rotation fan, since the rear impeller IM2 rotates in reverse, the rear impeller IM2 is capable of weakening the swirling flow of the wind forwarded from the front impeller IM1 and inhibiting spreading of the wind, hence generating a straight-traveling wind.

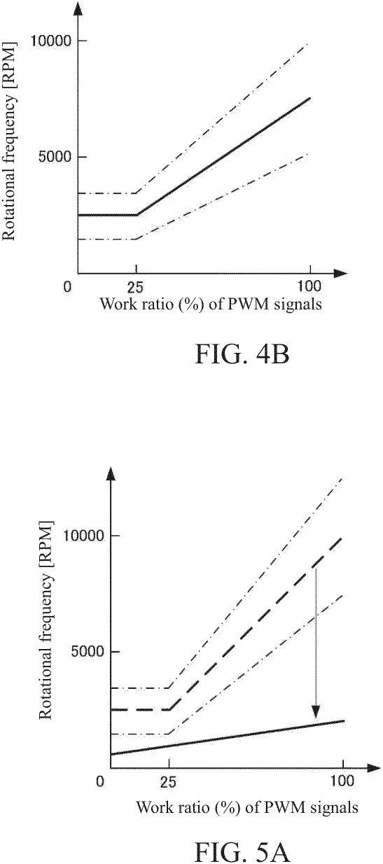

FIG. 4A shows a diagram of curves of rotational frequency characteristics of the fan F1 in a normal operation. FIG. 4B shows a diagram of curves of rotational frequency characteristics of the fan F2 in a normal operation. A solid line represents a target rotational speed and dotted-dashed lines represent upper and lower limits of a normal rotational frequency range.

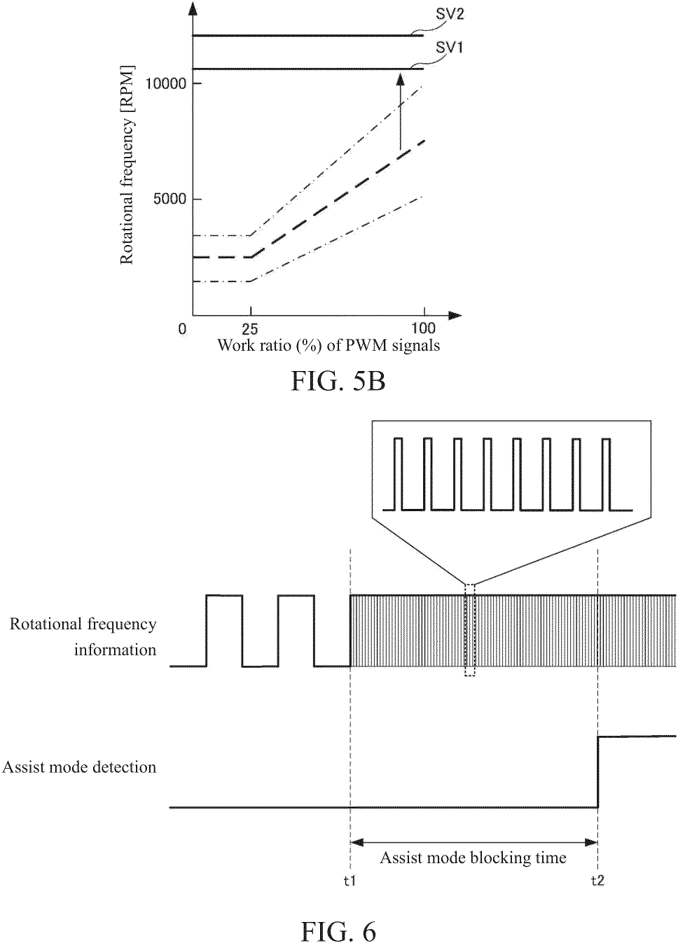

FIGS. 5A and 5B are diagrams of curves of rotational frequency characteristics of the fans F1 and F2 in an abnormal operation. A solid line represents a rotational frequency, dotted-dashed lines represent upper and lower limits of a normal rotational frequency range, and a dashed line represents a target rotational speed. The fan F1 rotates at a rotational frequency lower than the normal rotational frequency range represented by the dotted-dashed lines. It means that an anomaly has occurred in the fan F1, and the motor M1 operates at a low speed. During an anomaly of the lowered rotational frequency of the fan F1, the fan F2 switches from a normal mode to an assist mode to increase the rotational frequency so as to compensate for the lowered rotational frequency of the fan F1.

FIG. 6 shows a diagram of rotational frequency information during an abnormal operation (a motor rotating at a low speed). During a normal operation, the rotational frequency information is a square wave that outputs an H level with a certain working ratio (duty cycle) (approximately 40% to 60%). In FIG. 6, the frequency in the rotational frequency information rises from a timing t1 and the work ratio is below 25%. This means that an anomaly has occurred, and the anomaly is a first abnormal state in which a motor rotates at a low speed. The frequency in the rotational frequency information of a normal operation is set as, for example, hundreds of Hz, and the frequency in the rotational frequency information indicating the first abnormal state is set as, for example, tens of kHz.

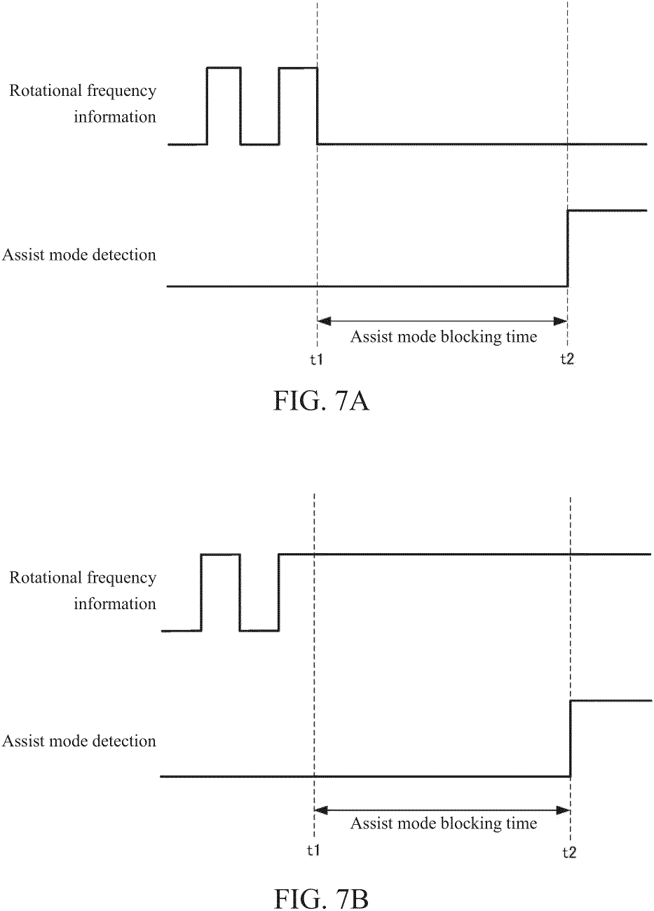

FIGS. 7A and 7B show diagrams of rotational frequency information during an abnormal operation (a locked motor). In FIG. 7A, the rotational frequency information starts to output only an L level from a timing t1. In addition, in FIG. 7B, the rotational frequency information starts to output only an H level from the timing t1. This means that an anomaly has occurred, and the anomaly is a second abnormal state in which a motor is locked (a stopped motor).

Both the first rotational frequency information and the second rotational frequency information may include each of the first abnormal state and the second abnormal state. The motor driving semiconductor integrated device 101 is configured as the control unit 2 being configured to switch a target rotational speed to a first set value SV1 regardless of whether the first rotational frequency information is in the first abnormal state or the second abnormal state. In addition, the motor driving semiconductor integrated device 102 is configured as the control unit 12 being configured to switch a target rotational speed to the first set value SV1 regardless of whether the first rotational frequency information is in the first abnormal state or the second abnormal state.

The motor driving semiconductor integrated device 101 is configured, if the first rotational frequency information sent from the motor driving semiconductor integrated circuit device 102 is still in the first abnormal state after a period between timings t1 and t2 in FIG. 6 has elapsed, to switch to the assist mode, and the control unit 2 switches the target rotational speed to the first set value SV1.

If the first rotational frequency information sent from the motor driving semiconductor integrated circuit device 102 is still in the second abnormal state after the period between the timings t1 and t2 in FIG. 7A and FIG. 7B has elapsed, the motor driving semiconductor integrated device 101 switches to the assist mode, and the control unit 2 of the motor driving semiconductor integrated circuit device 101 switches the target rotational speed to the first set value SV1. It may also be configured that, the control unit 2 of the motor driving semiconductor integrated circuit device 101 then maintains the target rotational speed at the first set value SV1, or it may be configured that the target rotational speed is switched to the second set value SV2 so as to further increase the rotational frequency. In addition, if the first rotational frequency information sent from the motor driving semiconductor integrated circuit device 102 is still in the second abnormal state after the period between the timings t1 and t2 in FIG. 7A and FIG. 7B has elapsed, the motor driving semiconductor integrated device 101 may switch to the assist mode, and the control unit 2 of the motor driving semiconductor integrated circuit device 101 immediately switches the target rotational speed to the second set value SV2.

The motor driving semiconductor integrated device 102 is configured, if the first rotational frequency information sent from the motor driving semiconductor integrated circuit device 101 is still in the first abnormal state after the period between the timings t1 and t2 in FIG. 6 has elapsed, to switch to the assist mode, and the control unit 12 switches the target rotational speed to the first set value SV1.

If the first rotational frequency information sent from the motor driving semiconductor integrated circuit device 101 is still in the second abnormal state after the period between the timings t1 and t2 in FIG. 7A and FIG. 7B has elapsed, the motor driving semiconductor integrated device 102 switches to the assist mode, and the control unit 2 switches the target rotational speed to the first set value SV1. It may also be configured that, the control unit 2 of the motor driving semiconductor integrated circuit device 102 then maintains the target rotational speed at the first set value SV1, or it may be configured that the target rotational speed is switched to the second set value SV2 so as to further increase the rotational frequency. In addition, if the first rotational frequency information sent from the motor driving semiconductor integrated circuit device 101 is still in the second abnormal state after the period between the timings t1 and t2 in FIG. 7A and FIG. 7B has elapsed, the motor driving semiconductor integrated device 102 may switch to the assist mode, and the control unit 2 of the motor driving semiconductor integrated circuit device 102 immediately switches the target rotational speed to the second set value SV2.

The fan includes the motor system described so far, and the plurality of impellers IM1 and IM2 configured to be provided with a rotational torque by each of the plurality of motors.

As shown in FIG. 3, the plurality of impellers IM1 and IM2 are arranged in series along a blowing direction D0. The plurality of motors include at least a motor that rotates in a first rotational direction D1 and at least a motor that rotates in a second rotational direction D2 opposite to the first rotational direction D1. Two fans are shown in FIG. 3; however, there may be three fans or more.

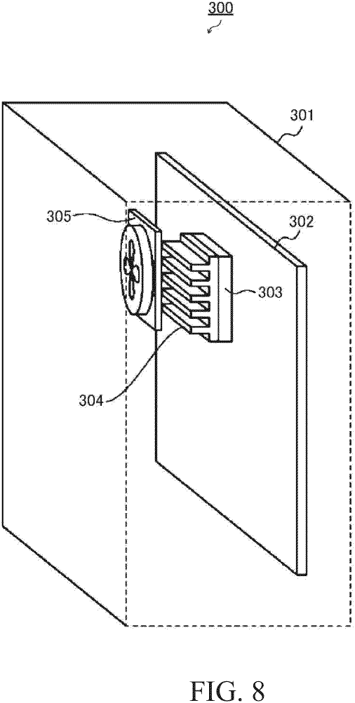

The double reverse rotation fan is used for, for example, cooling an LSI circuit for computation processing. FIG. 8 shows a diagram of a brief configuration example of a computer 300. The computer 300 includes a frame 301, a substrate 302, a computation processing LSI circuit 303, a heat sink 304 and a double reverse rotation fan 305. The double reverse rotation fan 305 is the double reverse rotation described so far.

The substrate 302, the computation processing LSI circuit 303, the heat sink 304 and the double fan reverse rotation fan 305 are disposed inside the frame 301. The computation processing LSI circuit 303 is arranged on the substrate 302, and the heat sink 304 is arranged on the computation processing LSI circuit 303. The double reverse rotation fan 305 blows cool air onto the heat sink 304.

In addition to the embodiments, various modifications may be implemented on the configurations of the present disclosure without departing from the scope of the technical inventive subject thereof. It should be understood that all aspects of the embodiment are exemplary rather than restrictive, and it should also be understood that the technical scope of the disclosure of the present application is not represented by the description associated with the embodiment but should include all equivalences within the scope of the appended claims and all modifications made within the scope.

A motor driving semiconductor integrated circuit (IC) device (101) in the above description is configured (as a first configuration) to include: a receiver (1) configured to receive first rotational frequency information transmitted by another motor driving semiconductor integrated circuit device (102); and a control unit (2) configured to variably control a rotational frequency of a self-driven motor according to the first rotational frequency information.

The motor driving semiconductor integrated circuit device of the first configuration is capable of monitoring a rotation state of a motor and compensating a capability of a malfunctioning motor. More specifically, the motor driving semiconductor integrated circuit device of the first configuration is capable of mutually monitoring a rotation state of a motor together with another motor driving semiconductor integrated circuit device and compensating a capability of a malfunctioning motor. Thus, by using the motor driving semiconductor integrated circuit device of the first configuration, a capability of a malfunctioning motor can be compensated without involving a microcomputer in a malfunction detection of a motor.

The motor driving semiconductor integrated circuit device of the first configuration may also be configuration (a second configuration) in which the first rotational frequency information includes a first abnormal state and a second abnormal state, respectively.

The motor driving semiconductor integrated circuit device of the second configuration may also be configuration (a third configuration) in which the control unit (2) is configured to switch a target rotational speed to a first set value (SV1) regardless of whether the other motor driving semiconductor integrated circuit device (102) is in the first abnormal state or the second abnormal state.

The motor driving semiconductor integrated circuit device of the second configuration may also be configuration (a fourth configuration) in which if the other motor driving semiconductor integrated circuit device (102) is in the first abnormal state, the control unit is configured to switch a target rotational speed to a first set value (SV1), and if it is in the second abnormal state, the control unit is configured to switch the target rotational speed to a second set value (SV2).

The motor driving semiconductor integrated circuit device of any one of the first to fourth configurations may be further configured (as a fifth configuration) to include: a transmission unit (3) configured to send second rotational frequency information indicating the rotational frequency of the self-driven motor to the other motor driving semiconductor integrated circuit device (102).

A motor system (201) of the above description may be configured (as a sixth configuration) to include a plurality of motor driving semiconductor integrated circuit devices of the fifth configuration and a plurality of motors configured to be respectively driven by the plurality of motor driving semiconductor integrated circuit devices.

The motor system of the sixth configuration may also be configuration (as a seventh configuration) in which each of the plurality of motor driving semiconductor integrated circuit devices is configured to transmit the second rotational frequency information and receive the first rotational frequency information.

In the motor system of the sixth configuration, the plurality of motor driving semiconductor integrated circuit devices are capable of mutually monitoring a rotation state of the motor and compensating a capability of a malfunctioning motor.

A fan of the above description is configured (as an eighth configuration) to include the motor system of the sixth or seventh configuration and a plurality of impellers (IM1, IM2) configured to be provided with a rotational torque by each of the plurality of motors.

The fan of the eighth configuration may also be configuration (a ninth configuration) in which the impellers are arranged in series along a blowing direction.

The fan of the ninth configuration may also be configuration (a tenth configuration) in which the plurality of motors include at least a motor (M1) that rotates in a first rotational direction and at least a motor (M2) that rotates in a second rotational direction opposite to the first rotational direction.

In the fan of the tenth configuration, the plurality of motor driving semiconductor integrated circuit devices are capable of mutually monitoring a rotation state of the motor and compensating a capability of a malfunctioning motor.

1. A motor driving semiconductor integrated circuit (IC) device, comprising:
a receiver, configured to receive a first rotational frequency information transmitted by another motor driving semiconductor IC device; and
a control unit, configured to variably control a rotational frequency of a self-driven motor according to the first rotational frequency information.

2. The motor driving semiconductor IC device of claim 1, wherein the first rotational frequency information may include a first abnormal state and a second abnormal state, respectively.

3. The motor driving semiconductor IC device of claim 2, wherein the control unit is configured to switch a target rotational speed to a first set value regardless of whether the other motor driving semiconductor IC device is in the first abnormal state or the second abnormal state.

4. The motor driving semiconductor IC device of claim 2, wherein
if the other motor driving semiconductor IC device is
in the first abnormal state, the control unit is configured to switch a target rotational speed to a first set value, and if
in the second abnormal state, the control unit is configured to switch the target rotational speed to a second set value.

5. The motor driving semiconductor IC device of claim 1, further comprising a transmission unit, configured to send a second rotational frequency information indicating the rotational frequency of the self-driven motor to the other motor driving semiconductor IC device.

6. The motor driving semiconductor IC device of claim 2, further comprising a transmission unit, configured to send a second rotational frequency information indicating the rotational frequency of the self-driven motor to the other motor driving semiconductor IC device.

7. The motor driving semiconductor IC device of claim 3, further comprising a transmission unit, configured to send a second rotational frequency information indicating the rotational frequency of the self-driven motor to the other motor driving semiconductor IC device.

8. The motor driving semiconductor IC device of claim 4, further comprising a transmission unit, configured to send a second rotational frequency information indicating the rotational frequency of the self-driven motor to the other motor driving semiconductor IC device.

9. A motor system, comprising:
a plurality of motor driving semiconductor IC devices; and
a plurality of motors, configured to be respectively driven by the plurality of motor driving semiconductor IC devices, wherein
each of the plurality of motor driving semiconductor IC devices is the motor driving semiconductor IC device of claim 5.

10. The motor system of claim 9, wherein each of the plurality of motor driving semiconductor IC devices is configured to transmit the second rotational frequency information and receive the first rotational frequency information.

11. A fan, comprising:
the motor system of claim 9; and
a plurality of impellers, configured to be provided with a rotational torque by each of the plurality of motors.

12. The fan of claim 11, wherein the plurality of impellers are arranged in series along a blowing direction.

13. The fan of claim 12, wherein the plurality of motors include at least a motor that rotates in a first rotational direction and at least a motor that rotates in a second rotational direction opposite to the first rotational direction.
